(19) United States
(12) Patent Application Publication
(10) Pub. No.: US 2005/0003335 A1
(43) Pub. Date: Jan. 6, 2005

(54) Cover for an assessment device

(76) Inventor: Kenneth John Everett, Johannesburg (ZA)

Correspondence Address: BURNS, DOANE, SWECKER & MATHIS, L.L.P., P.O. Box 1404, Alexandria, VA, 22313-1404, US

(21) Appl. No.: 10/610,654

(22) Filed: Jul. 2, 2003

(51) Int. Cl. G09B 7/00

(52) U.S. Cl. 434/322

(57) ABSTRACT

This invention relates to a cover for an assessment device which is used to obtain feedback from a customer and to evaluate a service or product. The cover includes a plurality of questions and possible answers to the questions displayed on the cover. A memory is located on the cover, the memory containing control data to be used by a processor in a base portion of the device to control the operation of the assessment device. The cover also includes an electrical connector for connecting the memory to the processor in the base portion.

### BACKGROUND OF THE INVENTION

This invention relates to a cover for an assessment device.

There are a number of assessment devices currently available in the marketplace which are used to obtain feedback from a customer and to evaluate a service or product.

Typically, these devices are located in a convenient position where the customer will have an opportunity to answer questions which are then stored for later use by the entity collecting the information.

Most of the devices include some kind of screen which present questions to the customer and have an input mechanism such as a keypad or touch screen to receive the customer's answers.

A drawback of these devices are that the screens are technologically complicated and are therefore difficult and expensive to manufacture.

One solution to this problem is provided in PCT patent application number WO 01/15120, the contents of which are incorporated herein by reference.

The disclosed invention includes a base portion including the electronics for the assessment device and a replaceable cover which includes a printed plastic sheet with the questions and answers thereon. When the cover is placed on the base, the answers are in line with buttons located underneath the cover and in order to answer a question, the customer presses down on the selected answer and thereby presses the underlying button to answer the respective question.

The answers are collected in a processor located in the base portion and then downloaded to a central server.

Although the assessment device described in the PCT patent application does away with the need for a screen to display various questions, the device is hindered by the fact that when the questions need to be changed, the cover needs to be changed with new printed questions. This is easy enough to achieve by simply replacing the printed plastic sheet with a new plastic sheet which has different questions and answers thereon.

However, it will be appreciated that depending on the questions and answers, the device will need to behave in different ways. For example, some questions may have two possible answers while other questions may have five possible answers.

This means that when the cover is replaced, control information needs to be transmitted to the processor in the base portion to instruct the processor regarding the correct control parameters for the device. This data flow from a central processor to each device complicates the mechanism of changing the covers.

The present invention seeks to address this.

### SUMMARY OF THE INVENTION

This invention relates to a cover for an assessment device, the cover comprising:
a plurality of questions and possible answers to the questions displayed on the cover,
a memory located on the cover, wherein the memory contains control data to be used by a processor in a base portion of the device to control the operation of the assessment device; and
an electrical connector for connecting the memory to the processor in the base portion.

The control data may include data to enable or disable a plurality of buttons located in the base portion, wherein the buttons are used to select the possible answers to the questions.

The control data may include data to indicate the length of time, in seconds, the device waits before resetting after sending a set of answers to a central server.

The control data may include to determine a buzzer duration.

The control data may include to determine whether or not the questions on the device need to be answered in order.

The control data may include to determine whether the device is remotely activated or activated by a magnetic stripe reader associated with the device.

Preferably, the cover further includes a physical connector for connecting the cover to the base portion of the assessment device.

### BRIEF DESCRIPTION OF THE DRAWINGS

FIG. 1 is a perspective view of an assessment device;

FIG. 2 is an exploded view of the device of FIG. 1 showing the cover and base separated with memory located in the cover which memory is electrically connected to the base;

FIG. 3 is a schematic circuit diagram of the cover memory; and

FIG. 4 is a screen dump of the cover program software.

### DESCRIPTION OF EMBODIMENTS

An assessment device 10 is used to obtain feedback from a customer to evaluate a service or product. The device is conveniently located where a user can easily answer the questions and thereby provide valuable information to the service or product provider.

The assessment device 10 includes a cover portion 12 and a base portion 14.

The cover portion 12 is formed from a plastic material and includes a printed insert with a plurality of questions 16 and possible answers to the questions 18 displayed thereon.

The printed insert also includes at least partially transparent regions 20 next to each question 16 so that a light emitting diode (LED) located in the base portion 14 can shine through the cover portion 12.

The LEDs are used to either indicate to a user of the device which question is to be answered next or which questions still need to be answered depending on how the assessment device is configured. This will be described in more detail below.

The cover portion 12 includes a physical connector for connecting the cover portion 12 to the base portion 14. In the illustrated embodiment, the physical connector is in the form of threaded holes in the cover portion 12 and corresponding holes in the base portion 14 so that the two can be connected together using screws. It will be appreciated that any other kind of physical connector, such as clips for example, could be used.

Located in the base portion 12 are a plurality of buttons 22, at least some of which are in line with the possible answers to the questions. This means that in order to answer a particular question, the user pushes down on a selected answer and thereby presses the underlying button.

All of the above is described in more detail in PCT patent application number WO 01/15120, the contents of which are incorporated herein by reference.

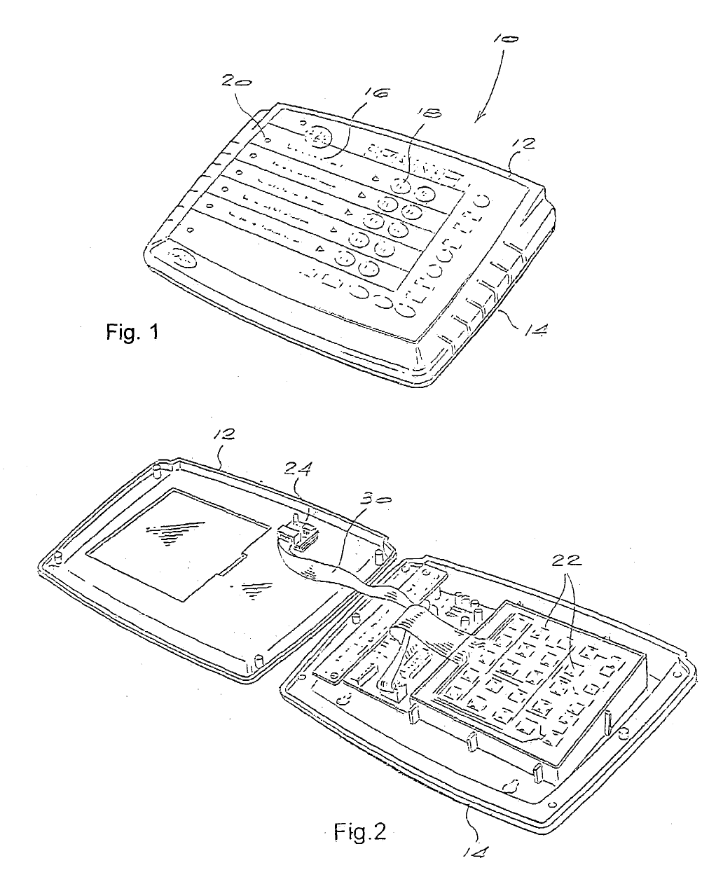

According to the present invention, the cover portion 12 includes a memory 24 connected to the inside of the cover portion. This can be clearly seen in FIG. 2.

The memory 24 is used to store control data which is used by a processor located in the base portion 14 to control the operation of the assessment device 10. Previously, each device was programmed with settings which required two way data communication between the device and a central server which caused numerous technical problems. By including the control data in the memory 24, the cover portion can easily be replaced and the overall operation of the device reconfigured without communication with a central server.

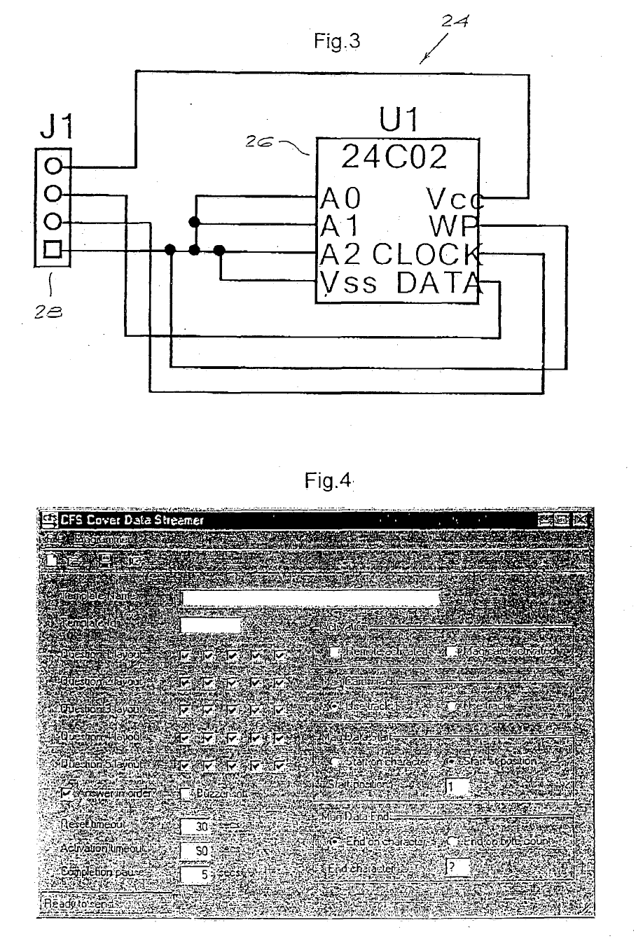

FIG. 3 is a schematic circuit diagram of the memory device 24. The device includes an EEPROM memory chip 26 which is connected to contact pads 28.

The contact pads 28 are used to connect the memory 24 to a processor (not shown) located in the base portion 14 using an electrical connector 30 which can be seen in FIG. 2.

Although the illustrated electrical connector is in the form of a ribbon cable, it is envisaged that a more direct electrical connector could be used such as one with electrical pins on the cover portion plugging straight into sockets fixed on the base portion 14.

The EEPROM chip 26 used for the prototype was an industry-standard 24 CO2I2C serial EEPROM having 256 bytes of memory available. Other chips such as a 24C01 or 24C04 could also be used.

The four contacts used to connect the EEPROM chip 26 are used for +5 volts, ground, a serial clock line and a serial data line.

When the device is switched on, the processor in the base portion 14 communicates with the cover memory 24, issues a read memory command and reads out the memory or a portion of the memory which contains the control data to be used by the processor.

The control data programmed into the memory 24 is programmed in using a cover programmer. The cover programmer is itself programmed using cover programmer software which allows the user to specify all of the variables that get set in the cover memory. This is easily accomplished by the user filling in a graphical user interface illustrated in FIG. 4. The various fields in FIG. 4 will be described in more detail below.

The cover programmer device is connected to a serial port of a personal computer (PC) and information is transmitted to the programmer device from the PC using RS232 at 2400 baud using the following pre-defined message structure:

| | Bytes |
|---|---|
| STX (0x02) | 1 |
| Template Id | 2 |
| Keyboard Map | 5 |
| Options | 2 |
| Reset Timeout | 1 |
| Completion Pause | 1 |
| MSR Start | 1 |
| MSR End | 1 |
| Activation Timeout | 1 |
| Keypad Len | 1 |
| Checksum | 2 |
| ETX (0x03) | 1 |

Once the programmer device has received the information from the PC, the programmer responds with a basic acknowledge using the following message structure:

| | Bytes |
|---|---|
| STX (0x02) | 1 |
| Acknowledge (0x06) | 1 |
| ETX (0x03) | 1 |

Once the cover programmer device has received all of the information, it can be used to connect to programme multiple cover memories with the same information.

The cover memory programmer is a device that consists of a microcontroller, serial (RS232) interface, buzzer, push button switch and a cover memory connector. The device operates by receiving a command via the serial connection from the PC software with all the required cover memory setting, as has been described above. The device keeps these settings in memory and allows the programmer to be disconnected from the PC once it has been sent the settings. This facilitates the process of programming a lot of cover memories as the operator does not have to interact with a PC to perform the programming.

Cover memories are programmed by connecting them to the programmer and pushing the switch. The microcontroller then attempts to connect to the cover memory on the I2C bus and sends a write command to the memory with all the settings. Once this is acknowledged from the memory chip it sends a read command to the memory and verifies that the settings have been correctly stored. The programmer also includes a checksum to allow the settings to be verified. The programmer beeps once (short) to indicate success or sounds 2 long beeps to indicate an error and the operator should retry.

Referring back to FIG. 4, the variables which a user is able to fill in on the screen are described in more detail as follows.

Template Name: A name, only for reference, to describe in more detail the current template. The template name does not get sent through to the device and does not need to correlate to anything in the database.

Template Id: This is the Template Id.

Question Layout: Each checkbox represents a button, if ticked, the button will be active to receive an answer.

Answer in Order: The device allows for any order answering, which also allows the user to change an answer at any stage, as long as they haven't selected the last unanswered question Checking this option forces the user to answer the questions in order and does not allow them to change their answers.

Buzzer Soft: Shortens the device beep by a small amount.

Reset Timeout: The length of time, in seconds, the device remains active after the first key press or after magnetic card activation. Partial answers are sent to the System Controller on completion of the reset timeout.

Activation Timeout: The length of time, in seconds, the device remains waiting for an answer after being remotely activated by an RS232 connection.

Completion Pause: The length of time, in seconds, the device waits before resetting after sending a set of answers to the System Controller.

Activation: The device can be activated either remotely or by a magnetic card reader associated with the device. Setting either of the activation options disables the device until the checked option occurs. If both remote and magnetic activation is selected, the device will activate on either of the two.

Mag Card Track: The track on the magnetic stripe that contains the required data.

Mag Data Start: The data can begin at a position, or on the finding of a particular character. Specify which of the two and then enter the position or the character.

Mag Data End: The data can end after a certain amount of characters (byte count) or on a the finding of a particular character. Specify which of the two and then enter the length or the character.

The magnetic strip format on different magnetic loyalty cards differs between vendors. The vendor can decide on the format of the data on the strip and this could be variable length data eg. a name or it could be fixed length data eg. 9 digit account number. The Mag Data Start and Mag Data End fields allow a flexible mechanism whereby the detail for the particular vendor's cards can be set. For example, South African Airways (SAA) have a Voyager number starting at position 6 and it is 7 chars long, whereas some vendors will use a special character (usually “?”) to mark the end of the data field.

Once all of the above information has been entered by the user, the send button is pushed and the data is sent to the cover programming device From there, the data is sent to the cover memory 24. In the prototype of the present invention, the data is stored in the cover memory 24 in the following format:

Variables

| | | |
|---|---|---|
| Template ID | The ID of the current device | 2 bytes |
| | template. | |
| Keyboard Map | The keys used (activated) for the current | 5 bytes |
| | template. | |
| Options | Options flags used for various settings | 2 bytes |
| | (see below). | |
| Reset Timeout | Length of time, in seconds, the device remains | 1 byte |
| | active after the first key press or after MSR | |
| | activation. Partial answers are sent to the | |
| | central server. | |
| Completion | Length of time, in seconds, the device waits | 1 byte |
| Pause | before resetting after sending a set of answers | |
| | to the System Controller | |
| Buzzer Soft | Reduces the buzzer duration. | 1 byte |
| MSR Start | The start byte or position of the MSR data. | 1 byte |
| | Byte or position set in options (see below). | |
| MSR End | The end byte or length of the MSR data. | 1 byte |
| | Byte or length set in options (see below). | |
| Activation | Length of time, in seconds, the device remains | 1 byte |
| Timeout | waiting after being remotely activated by | |
| | an RS232 connection. | |
| Keypad Length | Length of data to be input, if variable (set as 0) | 1 byte |
| | user selects # to show complete. | |

Options

| | |
|---|---|
| Bit 0 | Answer in Order? |
| Bit 1 | Remote Activated? |
| Bit 2 | MSR Activated? |
| Bit 3 | Use MSR Track 2? |
| Bit 4 | Start on character, not at position (MSR). |
| Bit 5 | End on character, not on length (MSR). |
| Bit 6 | MSR data CFS specific (starts with CFS). |
| Bit 7 | Activate Device on 1 keypad input |
| Bits 8-15 | Unassigned |

Thus it will be appreciated that the behavior of the device is altered depending on the data stored in the memory 24. For example, some questions on the assessment device will only have yes or no as possible answers in which case the data stored in the memory will only allow one of two buttons to be used in response to that particular question while other questions may have a range of answers in which case up to five of the buttons may be used in a response to that particular question. This information is stored in the memory 24.

Other information such as whether or not the questions need to be answered in order is also stored in the memory 24 as described above which alters the behavior of the device including whether or not the LEDs are illuminated in sequence, for example.

In order to change the set of questions and possible answers, the cover portion 12 is prepared with the new questions and answers printed thereon.

The control data stored in the memory 24 is formatted. The new cover can now simply replace the old cover portion 12 which is removed and unplugged from an existing assessment device before the new cover portion 12 is plugged into the remaining base portion 14.

Because the base portion 14 contains the relatively more expensive electronics of the system, it is cost effective to change the questions of the device without having to replace the whole device.

Furthermore, data received by the assessment device can be downloaded to a central server without full two-way communication being necessary which would be used to configure the processor in the case of the cover portion being replaced This also makes the system simpler and more cost-effective.

1. A cover for an assessment device, the cover comprising:
a plurality of questions and possible answers to the questions displayed on the cover;
a memory located on the cover, wherein the memory contains control data to be used by a processor in a base portion of the device to control the operation of the assessment device; and
an electrical connector for connecting the memory to the processor in the base portion.

2. A cover for an assessment device according to claim 1, wherein the control data includes data to enable or disable a plurality of buttons located in the base portion, wherein the buttons are used to select the possible answers to the questions.

3. A cover for an assessment device according to claim 1, wherein the control data includes data to indicate the length of time, in seconds, the device waits before resetting after sending a set of answers to a central server.

4. A cover for an assessment device according to claim 1, wherein the control data includes data to determine a buzzer duration.

5. A cover for an assessment device according to claim 1, wherein the control data includes data to determine whether or not the questions on the device need to be answered in order.

6. A cover for an assessment device according to claim 1, wherein the control data includes data to determine whether the device is remotely activated or activated by a magnetic stripe reader associated with the device.

7. A cover for an assessment device according to claim 1 further including a physical connector for connecting the cover to the base portion of the assessment device.
